(19) United States
(12) Patent Application Publication
(10) Pub. No.: US 2011/0285158 A1
(43) Pub. Date: Nov. 24, 2011

(54) Hand Held Scoop

(75) Inventor: Gary Workman, Lombard, IL (US)

(73) Assignee: Deslauriers, Inc.

(21) Appl. No.: 12/782,013

(22) Filed: May 18, 2010

(51) Int. Cl. A47F 13/08; A01B 1/02

(52) U.S. Cl. 294/178

(57) ABSTRACT

A one-piece plastic hand held scoop comprises a receptacle formed by an elongate peripheral wall closed at a rear end by a rear wall and open at a front end to define a product holding space. A first handle is connected to and extends transverse to the elongate peripheral wall proximate the front end. A second handle is connected to the elongate peripheral wall rearward of the first handle and extends longitudinally relative to the elongate peripheral wall.

### CROSS REFERENCE TO RELATED APPLICATIONS

There are no related applications.

### FIELD OF THE INVENTION

This invention relates to a hand held scoop and, more particularly, to a scoop unitarily formed of one-piece plastic construction.

### BACKGROUND OF THE INVENTION

A scoop, in one form, comprises a hand held implement used for digging, dipping or shoveling. These may be used, for example, in the construction industry, for scooping grout or similar materials. For example, the scoop may be used like a shovel to retrieve grout from a wheelbarrow, or the like, and pour the grout into concrete masonry units, also known as a cinder blocks.

Depending on the intended usage, the typical scoop includes one or more handles as required for the typical application. Known scoops used for handling grout use two spaced apart transverse handles. This results in a construction which is not ergonomically correct. This can make it more difficult to handle the product.

Also, typical known scoops are fabricated from multiple parts. This creates problems of breakage, loose or missing parts, and possibilities for poor assembly. The use of multiple parts can also increase manufacturing costs.

The present invention is directed to solving one or more of the problems discussed above, in a novel and simple manner.

### SUMMARY OF THE INVENTION

In accordance with the invention, there is provided a hand held scoop adapted to be ergonomically correct and of unitary construction.

Broadly, in accordance with one aspect of the invention, there is disclosed a hand held scoop comprising a receptacle formed by an elongate peripheral wall closed at a rear end by a rear wall and open at a front end to define a product holding space. A first handle is connected to and extends transverse to the elongate peripheral wall proximate the front end. A second handle is connected to the elongate peripheral wall rearward of the first handle and extends longitudinally relative to the elongate peripheral wall.

There is disclosed in accordance with another aspect of the invention a one-piece plastic hand held scoop comprising a receptacle formed by an elongate peripheral wall closed at a rear end by a rear wall and open at a front end to define a product holding space. A first handle is connected to the elongate peripheral wall proximate the front end. A second handle is connected to the elongate peripheral wall rearward of the first handle. The hand held scoop is unitarily formed of one piece plastic construction.

It is a feature to provide a support foot extending rearward from the rear wall.

It is another feature of the invention that the first and second handles comprise hollow handles opening into the product holding space. The first and second handles may be U-shaped.

It is still another feature of the invention that the elongate peripheral wall comprises a top wall and a bottom wall connected by opposite side walls.

It is a further feature of the invention that the bottom wall is longer than the top wall and a front edge of the side walls is angled downwardly from a front edge of the top wall. The bottom wall may be sloped downwardly from the side walls to a center line. A front edge of the bottom wall may be angled downwardly. The bottom wall may comprise a generally planar elongate center section connected between opposite angled wall sections to the side walls.

Further features and advantages of the invention will be readily apparent from the specification and from the drawings.

### BRIEF DESCRIPTION OF THE DRAWINGS

FIG. 1 is a perspective view of a hand held scoop in accordance with the invention;

FIG. 2 is a side elevation view of the hand held scoop of FIG. 1;

FIG. 3 is a top plan view of the hand held scoop of FIG. 1;

FIG. 4 is a rear elevation view of the hand held scoop of FIG. 1;

FIG. 5 is a front elevation view of the hand held scoop of FIG. 1;

FIG. 6 is a sectional view taken along the line 6-6 of FIG. 5;

FIG. 7 is a sectional view taken along the line 7-7 of FIG. 2;

FIG. 8 is a sectional view taken along the line 8-8 of FIG. 2; and

FIG. 9 is a detailed view of a cross-section of the handle taken from FIG. 6.

### DETAILED DESCRIPTION OF THE DRAWINGS

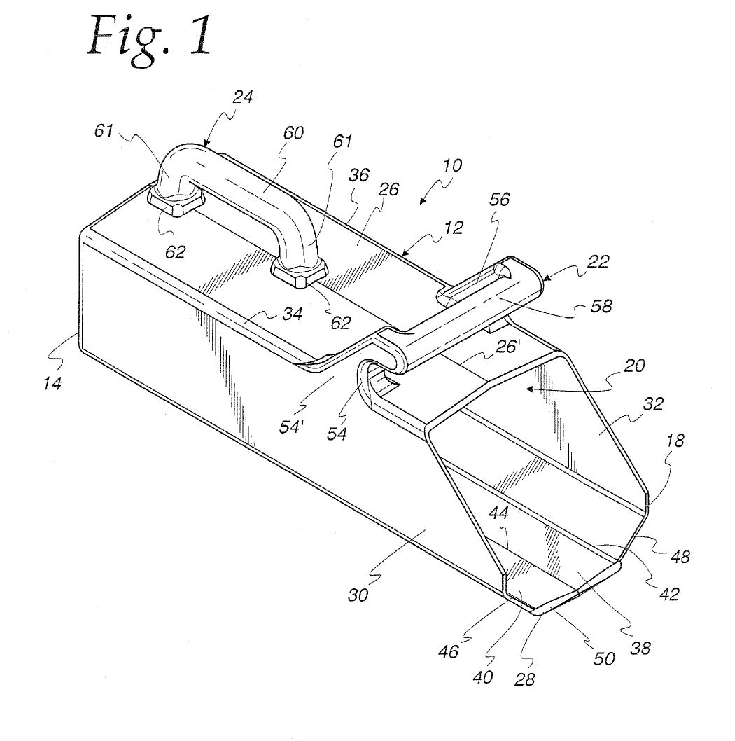

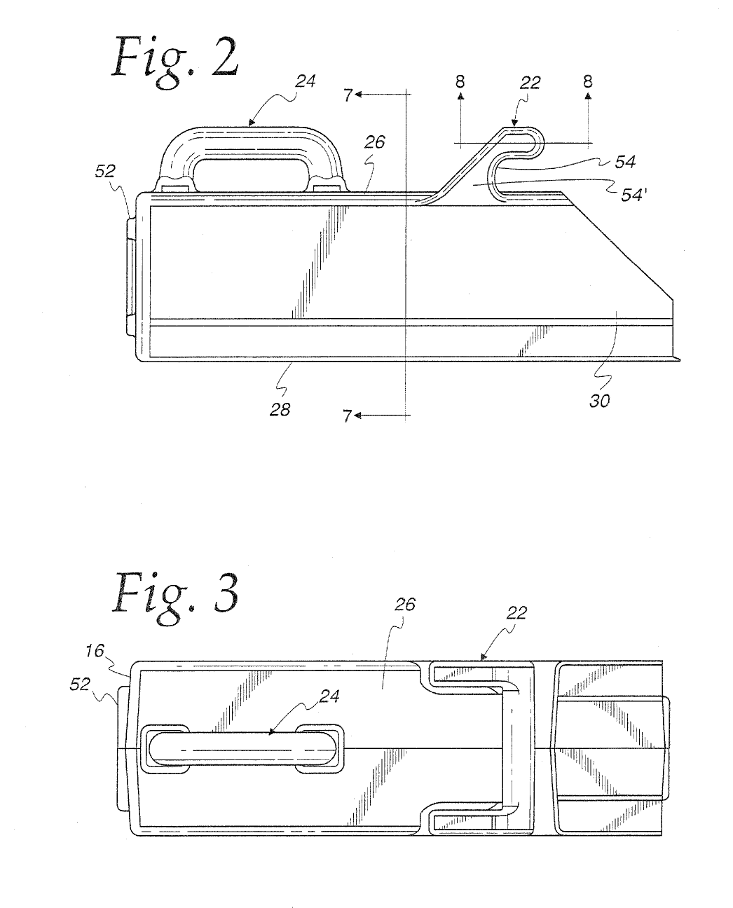

Referring initially to FIG. 1, a hand held scoop 10 in accordance with the invention is illustrated. The hand held scoop 10 is unitarily formed of one-piece plastic construction. Particularly, the scoop 10 may be formed by rotational molding using either high density or low density polyethylene. The wall thickness is generally uniform and may be on the order of 0.150″ throughout, it being understood that wall thickness may be greater at joints or the like to provide reinforcement, as described below.

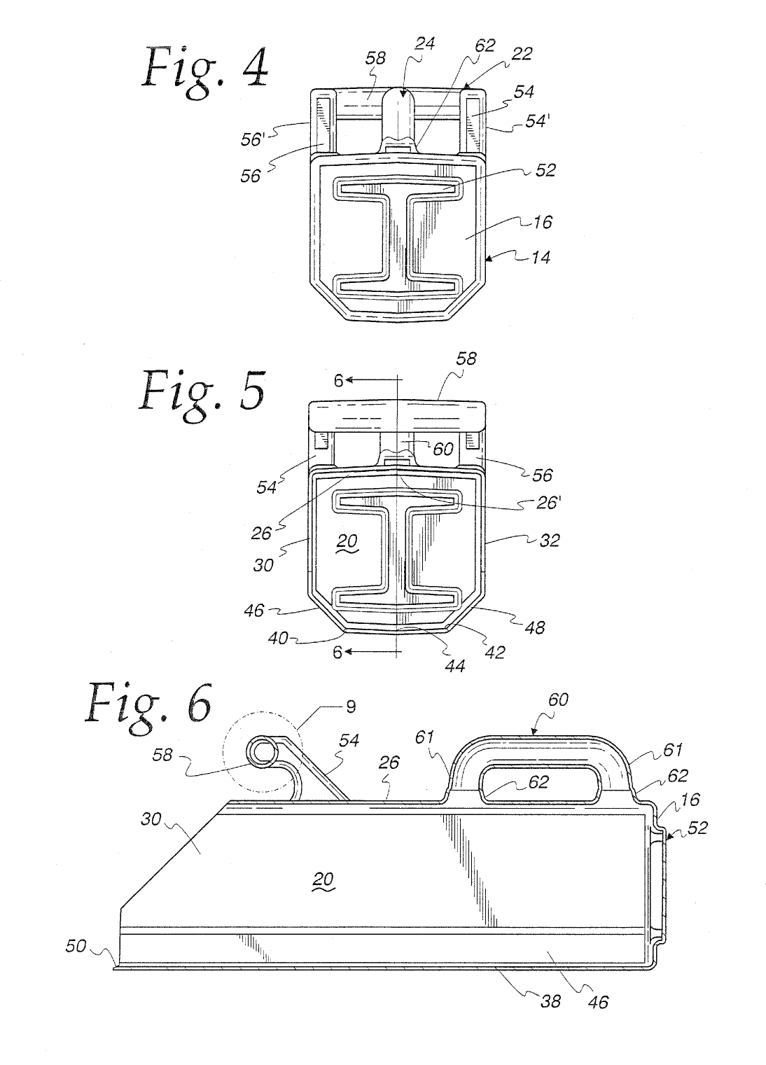

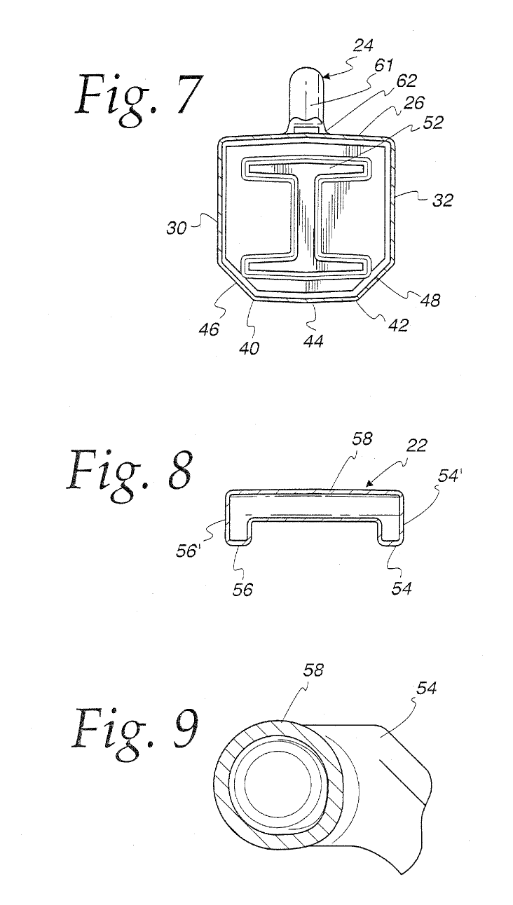

The scoop 10 comprises an elongate peripheral wall 12 closed at a rear end 14 by a rear wall 16, see FIG. 4, and open at a front end 18 to define a product holding space 20. As used herein, the word “front” is used relative to the open end of the product holding space 20 while the word “rear” is relative to the closed end of the product holding space 20. Owing to the peripheral wall 12 being longer from the rear 14 to the front 18 this direction is referred to herein as longitudinal, and across the peripheral wall 12 as transverse.

A first handle 22 is connected to and extends transverse to the elongate peripheral wall 12 proximate the front end 18. A second handle 24 is connected to the elongate peripheral wall 12 rearward of the first handle 22 and extends longitudinally relative to the elongate peripheral wall 12.

The elongate peripheral wall 12 comprises a top wall 26 and a bottom wall 28 connected between opposite side walls 30 and 32. The top wall 26 is generally planar except that it slopes slightly downward from a center line 26′ outwardly to the side walls 30 and 32, as shown in FIGS. 1 and 5. The top wall 26 is connected to the side walls 30 and 32 at rounded edges 34 and 36, respectively.

The bottom wall 28 comprises a center section 38 which is generally planar except that it slopes slightly downward from outer edges 40 and 42 to a center line 44. Opposite angled wall sections 46 and 48 are connected between the respective center section outer edges 40 and 42 and the respective opposite side walls 30 and 32. This slope aids in complete removal of product from the holding space 20. The bottom wall center section 38 includes a front edge 50 which is angled downwardly to aid in shoveling product.

A support foot 52 extends rearward y from the rear wall 16, see FIG. 4. The support foot 52 is in the shape of an “I” and is of a size corresponding to size of the rear wall 16. The support foot 52 provides reinforcement and a planar surface so that the scoop 10 can be supported on a horizontal support surface, much like a bucket, with the support foot 52 resting on the support surface and the front end 18 facing upwardly. Thus, the scoop 10 can stand on its end and not lose material, which could occur if it rests on the bottom wall 28 in the orientation shown in FIG. 1

The first handle 22 is generally U-shaped (see FIG. 5) and includes a first leg 54 and an opposite second leg 56 connected to a hand gripping cross piece in the form of a cylindrical body 58. The legs 54 and 56 are rectangular in cross section. Outside surfaces 54′ and 56′ of the respective legs 54 and 56 are flush with the respective side walls 30 and 32. The legs 54 and 56 are integrally formed with the top wall 26 and are wider at the joint with the top wall 26. The legs 54 and 56 are angled upwardly and frontwardly to position the cylindrical body 58 closer to the front end 18. The first handle 22 is hollow and opens into the product holding space 20.

The second handle 24 is U-shaped (see FIG. 6) and includes a hand gripping cross piece in the form of a cylindrical body 60 between opposite legs 61. The body 60 and the legs 61 are circular in cross section to define a tubular handle which is hollow and opens into the product holding space 20, as shown. A wider reinforcement collar 62 surrounds each end of the legs 61 where they are joined to the top wall 26.

In an illustrative embodiment of the invention, the scoop 10 is approximately 21″ in length. The bottom wall 38 extends substantially the full length of the scoop 10. The top wall 26 is shorter and is on the order of 16″ in length. Front edges of the side walls 30 and 32 are angled downwardly from a front edge of the top wall 26 to a front edge of the bottom wall 38. The angled front end along with the bottom wall center section front edge 50 being angled downwardly aids in scooping products, particularly from the bottom of a wheelbarrow or the like where the scoop can scrape along to lift as much material as possible. The provision of the first handle 22 extending transversely, while the second handle 24 extends longitudinally, provides an ergonomically correct configuration which can be quite helpful when scooping heavy materials, such as grout or gravel or the like. The use of a one piece molded unit eliminates problems of breakage or parts becoming separated with multiple part construction, and avoid concern with missing parts. The resulting product is relatively inexpensive to produce and is light weight. Moreover, being of all plastic construction, rust of metal parts is not a problem and a more durable construction results.

As will be apparent, the particular shape of the elongate peripheral wall may be different from that disclosed herein.

I claim:

1. A hand-held scoop comprising:
a receptacle formed by an elongate peripheral wall closed at a rear end by a rear wall and open at a front end to define a product holding space;
a first handle connected to and extending transverse to the elongate peripheral wall proximate the front end; and
a second handle connected to the elongate peripheral wall rearward of the first handle and extending longitudinally relative to the elongate peripheral wall.

2. The hand-held scoop of claim 1 further comprising support feet extending rearward form the rear wall.

3. The hand-held scoop of claim 1 wherein the first and second handles comprise hollow handles opening into the product holding space.

4. The hand-held scoop of claim 3 wherein the first and second handles are U-shaped.

5. The hand-held scoop of claim 1 wherein the elongate peripheral wall comprises a top wall and a bottom wall connected by opposite side walls.

6. The hand-held scoop of claim 5 wherein the bottom wall is longer than the top wall and a front edge of the side walls angle downwardly from a front edge of the top wall.

7. The hand-held scoop of claim 5 wherein the bottom wall is sloped downwardly from the side walls to a centerline.

8. The hand-held scoop of claim 5 wherein a front edge of the bottom wall is angled downwardly.

9. The hand-held scoop of claim 5 wherein the bottom wall comprises a generally planar elongate center section connected between opposite angled wall sections to the side walls.

10. The hand-held scoop of claim 1 wherein the hand-held scoop is unitarily formed of one-piece plastic construction.

11. A one-piece plastic hand-held scoop comprising:
a receptacle formed by an elongate peripheral wall closed at a rear end by a rear wall and open at a front end to define a product holding space;
a first handle connected to the elongate peripheral wall proximate the front end; and
a second handle connected to the elongate peripheral wall rearward of the first handle,
wherein the hand-held scoop is unitarily formed of one-piece plastic construction.

12. The hand-held scoop of claim 11 further comprising support feet extending rearward form the rear wall.

13. The hand-held scoop of claim 11 wherein the first and second handles comprise hollow handles opening into the product holding space.

14. The hand-held scoop of claim 13 wherein the first and second handles are U-shaped.

15. The hand-held scoop of claim 11 wherein the elongate peripheral wall comprises a top wall and a bottom wall connected by opposite side walls.

16. The hand-held scoop of claim 15 wherein the bottom wall is longer than the top wall and a front edge of the side walls angle downwardly from a front edge of the top wall.

17. The hand-held scoop of claim 15 wherein the bottom wall is sloped downwardly from the side walls to a centerline.

18. The hand-held scoop of claim 15 wherein a front edge of the bottom wall is angled downwardly.

19. The hand-held scoop of claim 15 wherein the bottom wall comprises a generally planar elongate center section connected between opposite angled wall sections to the side walls.

20. The hand-held scoop of claim 11 wherein the first handle extends transverse to the elongate peripheral wall and the second handle extends longitudinally to the elongate peripheral wall.
